(19) United States
(12) Patent Application Publication
(10) Pub. No.: US 2010/0145538 A1
(43) Pub. Date: Jun. 10, 2010

(54) METHOD OF LIMITING A POWER SUPPLY CURRENT AND OPTICAL DEVICE

(75) Inventors: Hendrikus Albertus. Johanna Looijmans, Eindhoven (NL); Cornelius Antonius Hezemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,642

(22) PCT Filed: Mar. 16, 2006
(86) PCT No.: PCT/IB2006/050817

§ 371 Date: Sep. 25, 2007

(30) Foreign Application Priority Data
Mar. 30, 2005 (EP) 05102511.2

(51) Int. Cl. H02J 1/14; G11B 19/28

(52) U.S. Cl. 700/295; 307/32

(57) ABSTRACT

The present invention relates to a method of limiting a power supply current in a system comprising a power supply (10), a motor (12) operating at different speeds, a driver (14) for driving the motor and a controller (16) for controlling the driver, the method comprising the steps of: specifying a first value that is related to a maximum power supply current (I_{PSmax}); determining a second value that is related to an electromagnetic force-dependent voltage (V_{EMF}) of the motor; determining a desired third value (C_{des}) that is related to a desired motor current (I_{Mdes}); determining a first boundary value (a) and a second boundary value (b) for the third value, taking into account the first value and the second value; comparing the boundary values (a) and (b) to the third value (C_{des}); and setting the third value in dependence on the result of the comparing step

The present invention relates to a method of limiting a power supply, and particularly to a method of limiting a power supply of an optical driver within an optical device. The present invention further relates to an optical device in which a method of limiting a power supply current can be implemented.

In an optical device the optical disc, driven by an electrical motor, often needs to be accelerated or decelerated, for example at starting up or stopping of the drive, or when changing from one speed mode to the other. Changing the speed of the disc in an optical drive will cause high current peaks drawn from the power supply. Especially in battery-powered portable equipment these high current peaks form a problem, because they will heavily load the battery.

The problem of high current peaks at speed changes of the disc is already known, and also solutions are known. These solutions, however, suffer from the disadvantages that they need to be implemented in hardware, for example as a part of a driver circuit, and/or that they limit the motor current instead of the actual current drawn from the power supply, i.e. the battery.

It is an object of the invention to provide a method and an optical device so that accelerating and decelerating of the disc with reduced current peaks is possible.

The above objects are solved by the features of the independent claims. Further developments and preferred embodiments of the invention are outlined in the dependent claims.

In accordance with the invention, there is provided a method of limiting a power supply current in a system comprising a power supply, a motor operating at different speeds, a driver for driving the motor and a controller for controlling the driver, the method comprising the steps of:

specifying a first value that is related to a maximum power supply current (I_{PSmax});

determining a second value that is related to an electromagnetic force-dependent voltage (V_{EMF}) of the motor;

determining a desired third value (c_{des}) that is related to a desired motor current (I_{Mdes});

determining a first boundary value (a) and a second boundary value (b) for the third value, taking into account the first value and the second value;

comparing the boundary values (a) and (b) to the third value (c_{des}); and

setting the third value in dependence on the result of the comparing step.

Thus, the power supply current can be limited, thereby avoiding undesired effects caused by high current peaks, particularly when accelerating or decelerating an optical disc.

According to a preferred embodiment the first value is the maximum power supply current;

the second value is the electromagnetic force-dependent voltage (V_{EMF}) of the motor; and

the third value (c) is the desired motor current (I_{Mdes}).

Based on this the present invention can be performed by evaluating the current and voltage values.

In this regard, it is advantageous that the step of determining the second value comprises the steps of:

determining the current motor speed; and

multiplying the current motor speed by a motor constant.

Thereby, the electromagnetic force-dependent voltage (V_{EMF}) can be calculated on the basis of a tacho measurement and a multiplication of the measurement results by a well-known motor-specific value.

According to a preferred embodiment of the present invention the step of determining the boundary value (a) comprises the step of:

calculating the boundary value (a) by using the equation:

$$a = \frac{- {V}_{EMF} - \sqrt{{V}_{EMF}^{2} + 4 {R}_{M} {V}_{CC} {I}_{PSmax}}}{2 {R}_{M}}$$

wherein:

R_{M} is the ohmic resistance of the motor; and

V_{CC} is the source voltage supplied to the driver.

Similarly, the step of determining the boundary value (b) comprises the step of:

calculating the boundary value (b) by using the equation:

$$b = \frac{- {V}_{EMF} + \sqrt{{V}_{EMF}^{2} + 4 {R}_{M} {V}_{CC} {I}_{PSmax}}}{2 {R}_{M}}$$

wherein:

R_{M} is the ohmic resistance of the motor; and

V_{CC} is the source voltage supplied to the driver.

Thus, the values a and b can be exactly calculated from previously determined values and from well-known properties of the motor. The calculation can take place in a digital signal processor (DSP) in which the controller for controlling the driver of the motor is generally embedded.

According to a further embodiment of the present invention the step of determining the boundary value comprises the step of approximating the boundary value on the basis of a relation between a value that is related to the power supply current (I_{PS}), a value that is related to the electromagnetic force-dependent voltage (V_{EMF}), and a value that is related to the motor current (I_{M}).

Similarly, the step of determining the boundary value (b) comprises the step of approximating the boundary value (b) on the basis of a relation between a value that is related to the power supply current (I_{PS}), a value that is related to the electromagnetic force-dependent voltage (V_{EMF}), and a value that is related to the motor current (I_{M}).

Thus an exact calculation of the values a and b is not necessarily required; a simple approximation by a linear relation of I_{M} as a function of I_{PS} and V_{EMF} can also lead to acceptable results.

According to a particular embodiment of the present invention, the power supply current to be limited is a current drawn from the power supply;

the third value is set to c_{des}, if c_{des} is situated between a and b;

the third value is set to a, if c_{des} is smaller than a; and

the third value is set to b, if c_{des} is larger than b.

Therefore, in case of limiting the current drawn from the power supply a simple algorithm on the basis of the previously determined values is sufficient to effectively limit the current drawn from the power supply.

Similarly, the power supply current to be limited is a current fed back to the power supply;

the third value is set to c_{des}, if c_{des} is smaller than a or larger than b; and

the third value is set to a, if c_{des} is situated between a and b.

Thus, the present invention can also be employed in connection with a system in which feeding back of the motor current is possible.

In accordance with the invention, there is further provided an optical device comprising a power supply, a motor operating at different speeds, a driver for driving the motor and a controller for controlling the driver, the device being capable of limiting a power supply current and the device further comprising:

means for specifying a first value that is related to a maximum power supply current (I_{PSmax});

means for determining a second value that is related to an electromagnetic force-dependent voltage (V_{EMF}) of the motor;

means for determining a third value (c_{des}) that is related to a desired motor current (I_{Mdes});

means for determining a first boundary value (a) and a second boundary value (b) for the third value, taking into account the first value and the second value;

means for comparing the boundary values (a) and (b) to the third value (c); and

means for setting the third value in dependence on the result of the comparing step.

Preferably, the means for specifying, determining, comparing and setting are at least partly provided by a proportional integral (PI) controller.

Thus, the invention provides a method for accelerating and decelerating the disc in such a way that the high current peaks are reduced. The method provided by the invention will not suffer from the disadvantages as described with respect to solutions already known. One reason for this is that it can be implemented as a piece of code on a digital signal processor (DSP) that will often already be available in the optical drive system because the controllers are implemented in a DSP. The other reason is that the proposed method actually limits the current drawn from the power supply, rather than relying on a limitation of the motor current. The invention will provide an extra function apart from the limitation of a current drawn from the power supply: if a driver is used that is capable of feeding back current to the power supply, the invention can be used to limit this current or even to prevent the current from flowing back to the power supply.

These and other aspects of the invention will be apparent from and elucidated with reference to the embodiments described hereinafter.

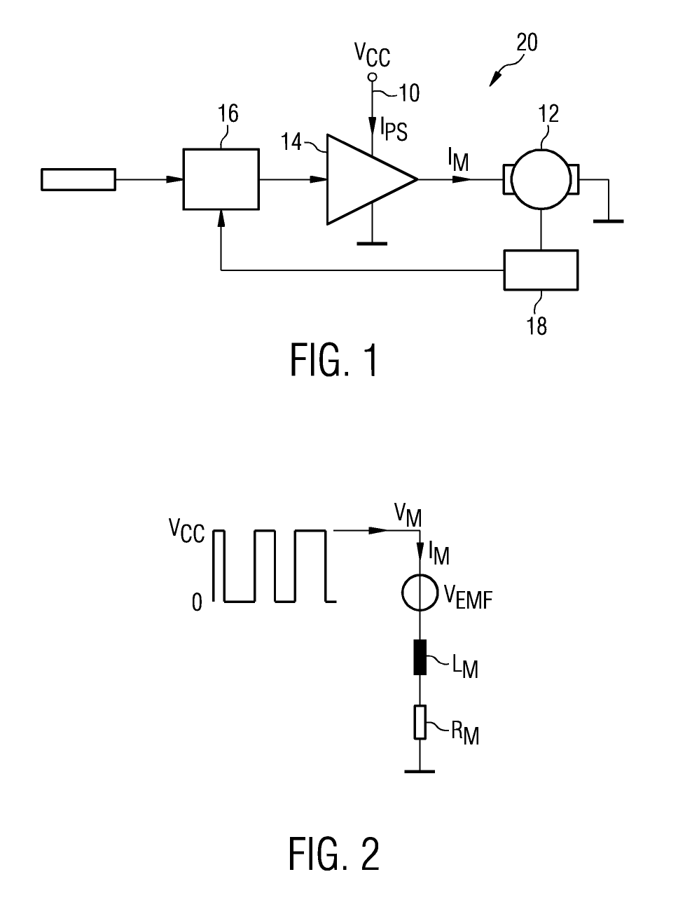

FIG. 1 shows a schematic diagram of a feedback-controlled motor loop.

FIG. 2 shows an electrical model of a motor.

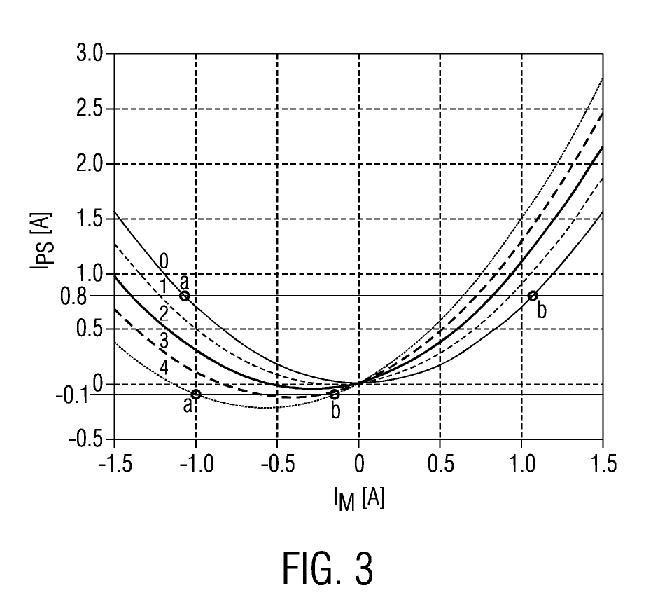

FIG. 3 shows a diagram illustrating the power supply current for various values of V_{EFM}.

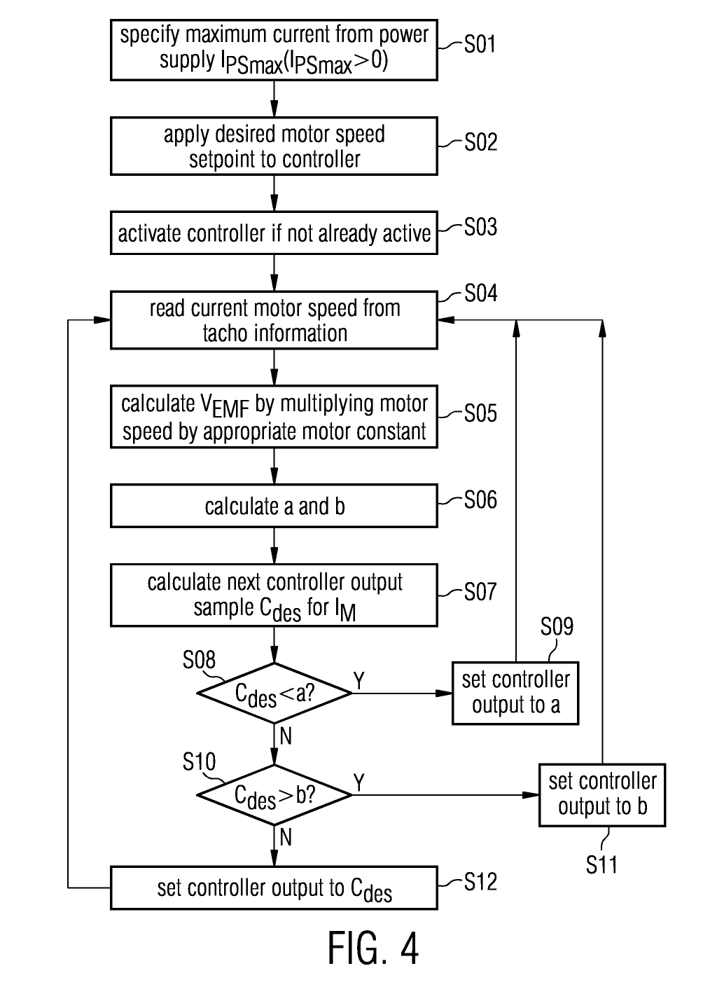

FIG. 4 shows a flow chart illustrating a method according to the present invention.

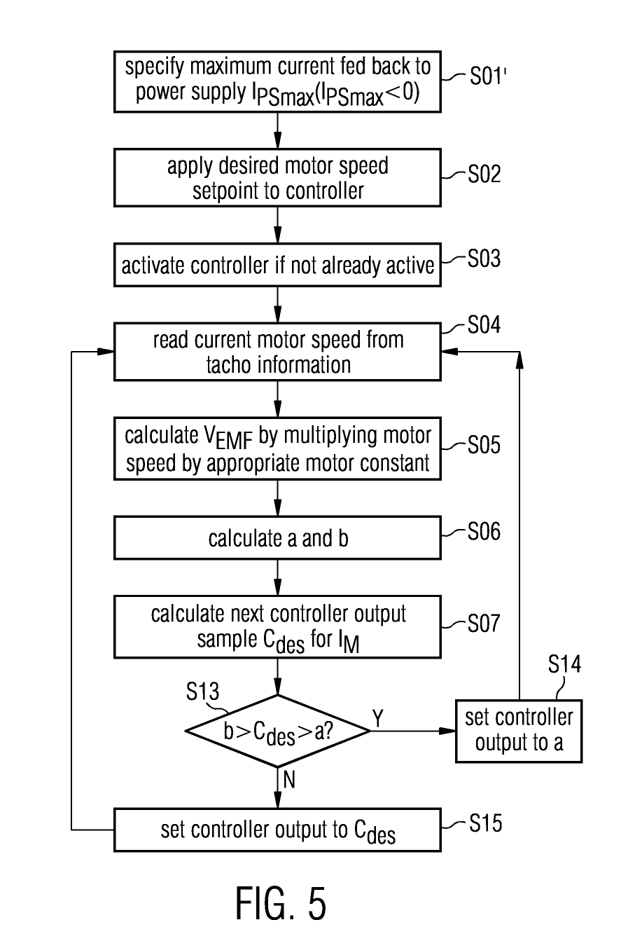

FIG. 5 shows a flow chart illustrating a further method according to the present invention.

FIG. 1 shows a schematic diagram of a feedback-controlled motor loop. The feedback loop 20 in general comprises a PI controller 16 that will control the speed of the motor to a specified setpoint. A setpoint signal 22 is input to the PI controller 16. For example, the controller 16 is implemented in a DSP. A power driver 14 is provided that drives the motor 12 by sending a current I_{M} through the motor. For example, the invention applies to switching drivers, which are commonly used for optical drivers because they are very efficient. A tacho 18 is provided that sends speed information to the PI controller by outputting tacho pulses. The tacho 18, i.e. means for counting tacho pulses, can also be implemented in the motor 12. The driver 14 is provided by a supply voltage V_{CC}, so that a power supply current I_{PS} is delivered to the driver 14.

The motor current I_{M} is proportional to the output of the PI controller when using a current output driver. Because the properties of this controller can be easily modified, particularly when implemented in a DSP, it is useful to derive the relation between the current drawn from the power supply I_{SP} and the motor current I_{M}. When this relation is known, a strategy for limiting the power supply current by means of controlling the motor current can be proposed.

FIG. 2 shows an electrical model of a motor. A pulse width modulated (PWM) signal is applied to the motor by the switching driver (see FIG. 1).

The power consumed by the motor will be:

P_{M}=I_{M}²R_{M}+I_{M}V_{EMF}

If it is assumed that the switching driver has ideal properties, then the power requested from the power supply that feeds the driver will be equal to the power that the motor consumes. In practice this driver will not be free of loss of course. For example the output impedance will not be 0, which can dissipate a significant amount of energy. The effect of these non-ideal system aspects can simply be included in the calculations, but they are omitted from this description because they are of minor importance to the invention. So:

P_{PS}=P_{M}=I_{M}²R_{M}+I_{M}V_{EMF}

Then, the current drawn from the power supply is:

$${I}_{PS} = \frac{{P}_{M}}{{V}_{CC}} = \frac{{I}_{M}^{2} {R}_{M} + {I}_{M} {V}_{EMF}}{{V}_{CC}}$$

FIG. 3 shows a diagram illustrating the power supply current for various values of V_{EFM}. The relation is plotted for a range of motor currents and at various V_{EMF} value curves 0 to 4. Two lines have been added at I_{PS}=0.8 A and I_{PS}=−0.1 A as two examples of specified maximum allowed currents. Each line represents a specific V_{EMF} value. For the V_{EMF}=0 curve, the crossings with the I_{PS}=0.8 A level are shown. For V_{EMF}=4, the crossings with the I_{PS}=−0.1 A level are shown. These a and b crossings are used in calculations below.

To find at which motor currents the power supply current crosses the specified maximum I_{PSmax} the following equation has to be solved:

$$\frac{{I}_{M}^{2} {R}_{M} + {I}_{M} {V}_{EMF}}{{V}_{CC}} + {I}_{PSmax}$$

This provides the following two solutions a and b for boundary values of I_{M}:

$$a = \frac{- {V}_{EMF} - \sqrt{{V}_{EMF}^{2} + 4 {R}_{M} {V}_{CC} {I}_{PSmax}}}{2 {R}_{M}}$$

$$and$$

$$b = \frac{- {V}_{EMF} + \sqrt{{V}_{EMF}^{2} + 4 {R}_{M} {V}_{CC} {I}_{PSmax}}}{2 {R}_{M}}$$

From these equations for a and b five different situations grouped in group I and group II can be defined:

I: Positive I_{PS}, i.e. current is drawn from the power supply:

1. the motor is either accelerating or decelerating, and the current drawn from the power supply does not exceed the specified limit I_{PSmax}.

2. the motor is accelerating and the current drawn from the power supply exceeds the maximum current I_{PSmax}.

3. the motor is decelerating and the current drawn from the power supply exceeds the maximum current I_{PSmax}.

II: Negative I_{PS}, i.e. current is fed back to the power supply:

1. the motor is decelerating and the absolute value of the current flowing back to the power supply exceeds the maximum current I_{PSmax}.

2. the motor is decelerating and the absolute value of the current flowing back to the power supply does not exceed the maximum current I_{PSmax}.

The invention now uses the relations described above to propose two types I and II of motor control strategies, as a part of the motor PI control loop:

I. Limiting of the power supply current peaks during accelerating and decelerating of the motor (the gain of the driver is assumed to be 1 A/V for this example):

1. specify a maximum current from the power supply I_{PSmax} (I_{PSmax}>0)

2. apply desired motor speed setpoint to the controller

3. while controller is active

4. read current motor speed from tacho information

5. calculate V_{EMF} by multiplying the motor speed by the appropriate motor constant

6. calculate a and b

7. calculate next controller output sample for I_{M} (c_{des})

8. if c_{des}<a then set controller output to a else if c_{des}>b then set controller output to b else set controller output to c_{des}

9. end

II. Limiting of the current fed back to the power supply when decelerating the motor (the gain of the driver is assumed to be 1 A/V for this example): meant for this purpose:

1. specify a maximum current to the power supply I_{PSmax} (I_{PSmax}<0)

2. apply desired motor speed setpoint to the controller

3. while controller is active

4. read current motor speed from tacho information

5. calculate V_{EMF} by multiplying the motor speed by the appropriate motor constant

6. calculate a and b

7. calculate next controller output sample for I_{M} (cₐ.)

8. if c_{des}>a and c_{des}<b then set controller output to a else set controller output to c_{des}

9. end

In principle, in the previously mentioned steps 8, when the controller output is set to a or b, this is not necessarily required. As far as only the appropriate current limitation is concerned, the controller output could also be set to any value that leads to an “allowed” power supply current.

The calculation of a and b can be done by implementing the above formulae in the DSP code, but a simple approximation by a linear relation between I_{M} and I_{PS} will give acceptable results as well.

The method according to the present invention is further explained with reference to FIGS. 4 and 5 which show flow charts. According to FIG. 4, in which a limitation of a current drawn from the power supply is concerned, in a first step S01 a maximum current from the power supply is specified. In a next step S02 the desired motor speed set point is supplied to the controller. In step S03 the controller is activated if it is not already active. According to step S04 the current motor speed information is read from the tacho. Step S05 calculates V_{EMF} by multiplying the motor speed by the appropriate motor constant. In a next step S06 the values a and b are calculated, and in step S07 the next controller output sample c_{des} is calculated. In Step S08, c_{des} is compared with a. If c_{des} is smaller than a, the controller output is set to a in step S09. Following step S09, the loop returns back to step S04, in which the current motor speed information is read from the tacho. If the answer in step S08 is “no”, in step S10 the value c_{des} is compared to b. If c_{des} is larger than b, the controller output is set to b in step S11 and the loop returns back to step S04. If the answer in step S10 is “no”, the controller output is set to c_{des} in step S12, and the loop returns to step S04.

According to the method that is illustrated in FIG. 5, the power supply current is limited for the case of a current feedback to the power supply. Thus, the maximum current to be fed back to the power supply is specified in step S01′. The steps S02 to S07 correspond to steps S02 to S07 in FIG. 4. After step S07, the value c_{des} is compared to the values a and b in step S13. If c_{des} is between the values a and b, the controller output is set to a in step S14. After step S14 the loop returns back to step S04. If the answer in step 13 is “no”, the controller output is set to c_{des} in step S15. After the step S15 the loop returns back to step S04.

The present invention can be applied in many technical fields. A particular area of interest is that of optical drivers for portable equipment such as notebook computers or portable AV devices.

Equivalents and modifications not described above may also be employed without departing from the scope of the invention, which is defined in the accompanying claims.

1. A method of limiting a power supply current in a system comprising a power supply (10), a motor (12) operating at different speeds, a driver (14) for driving the motor and a controller (16) for controlling the driver, the method comprising the steps of:
specifying a first value that is related to a maximum power supply current (I_{PSmax});
determining a second value that is related to an electromagnetic force-dependent voltage (V_{EMF}) of the motor;
determining a desired third value (c_{des}) that is related to a desired motor current (I_{Mdes});
determining a first boundary value (a) and a second boundary value (b) for the third value, taking into account the first value and the second value;
comparing the boundary values (a) and (b) to the third value (c_{des}); and
setting the third value in dependence on the result of the comparing step.

2. The method according to claim 1, wherein
the first value is the maximum power supply current (I_{PSmax});
the second value is the electromagnetic force-dependent voltage (V_{EMF}) of the motor; and
the third value (c) is the desired motor current (I_{Mdes}).

3. The method according to claim 1, wherein the step of determining the second value comprises the steps of:
determining the current motor speed; and
multiplying the current motor speed by a motor constant.

4. The method according to claim 1, wherein the step of determining the boundary value (a) comprises the step of:
calculating the boundary value (a) by using the equation:
$$a = \frac{- {V}_{EMF} - \sqrt{{V}_{EMF}^{2} + 4 {R}_{M} {V}_{CC} {I}_{PSmax}}}{2 {R}_{M}}$$
wherein:
R_{M} is the ohmic resistance of the motor; and
V_{CC} is the source voltage supplied to the driver.

5. The method according to claim 1, wherein the step of determining the boundary value (b) comprises the step of:
calculating the boundary value (b) by using the equation:
$$b = \frac{- {V}_{EMF} + \sqrt{{V}_{EMF}^{2} + 4 {R}_{M} {V}_{CC} {I}_{PSmax}}}{2 {R}_{M}}$$
wherein:
R_{M} is the ohmic resistance of the motor; and
V_{CC} is the source voltage supplied to the driver.

6. The method according to claim 1, wherein the step of determining the boundary value (a) comprises the step of approximating the boundary value (a) on the basis of a relation between a value that is related to the power supply current (I_{PS}), a value that is related to the electromagnetic force-dependent voltage (V_{EMF}), and a value that is related to the motor current (I_{M}).

7. The method according to claim 1, wherein the step of determining the boundary value (b) comprises the step of approximating the boundary value (b) on the basis of a relation between a value that is related to the power supply current (I_{PS}), a value that is related to the electromagnetic force-dependent voltage (V_{EMF}), and a value that is related to the motor current (I_{M}).

8. The method according to claim 1, wherein
the power supply current to be limited is a current drawn from the power supply;
the third value is set to c_{des}, if c_{des} is situated between a and b;
the third value is set to a, if c_{des} is smaller than a; and
the third value is set to b, if c_{des} is larger than b.

9. The method according to claim 1, wherein
the power supply current to be limited is a current fed back to the power supply;
the third value is set to c_{des}, if c_{des} is smaller than a or larger than b; and
the third value is set to a, if c_{des} is situated between a and b.

10. An optical device comprising a power supply, a motor operating at different speeds, a driver for driving the motor and a controller for controlling the driver, the device being capable of limiting a power supply current and the device further comprising:
means (16) for specifying a first value that is related to a maximum power supply current (I_{PSmax});
means (16, 18) for determining a second value that is related to an electromagnetic force-dependent voltage (V_{EMF}) of the motor;
means (16) for determining a third value (c_{des}) that is related to a desired motor current (I_{Mdes});
means (16) for determining a first boundary value (a) and a second boundary value (b) for the third value, taking into account the first value and the second value;
means (16) for comparing the boundary values (a) and (b) to the third value (c); and
means (16) for setting the third value in dependence on the result of the comparing step.

11. The optical device according to claim 10, wherein the means for specifying, determining, comparing and setting are at least partly provided by a proportional integral (PI) controller.
